(19) United States
(12) Patent Application Publication
(10) Pub. No.: US 2026/0289738 A1
(43) Pub. Date: Sep. 24, 2026

(54) DIFFUSION BRIDGE FRAMEWORK FOR CLOUD REMOVAL IN SATELLITE IMAGERY

(71) Applicant: Mitsubishi Electric Research Laboratories, Inc., Cambridge, MA (US)

(72) Inventors: Suhas Lohit, Boston, MA (US); Yuyang Hu, St. Louis, MO (US); Tim Marks, Boston, MA (US)

(73) Assignee: Mitsubishi Electric Research Laboratories, Inc., Cambridge, MA (US)

(21) Appl. No.: 19/088,207

(22) Filed: Mar. 24, 2025

(51) Int. Cl. G06T 5/60; G06T 5/50

(52) U.S. Cl. CPC G06T 5/60; G06T 5/50; G06T 2207/10044; G06T 2207/20081; G06T 2207/20084

(57) ABSTRACT

A system and method for generating a cloud-free optical satellite image from a cloudy optical satellite image using a diffusion bridge (DB) framework that includes iteratively applying a reverse diffusion bridge process, such that each iteration progressively refines the input image by reducing cloud-induced noise while preserving structural and spectral details. The diffusion bridge framework models a deterministic transition from the cloudy image distribution to the target cloud-free image distribution. The system may further incorporate Synthetic Aperture Radar (SAR) imagery to guide the structural recovery process, using a two-branch multimodal architecture comprising an optical image restoration branch and a SAR feature extraction branch. The branches are interconnected through SAR Fusion Blocks (SFBlocks), which employ cross-attention mechanisms to align and merge structural information from SAR images with spectral details from optical images. This multimodal diffusion bridge framework improves cloud removal accuracy, reduces artifacts, and maintains computational efficiency.

### TECHNICAL FIELD

This disclosure relates to the field of satellite image processing, and more specifically to methods and systems for generating cloud-free optical satellite images using diffusion bridges.

### BACKGROUND

Satellite imagery plays a critical role in numerous applications, including environmental monitoring, urban planning, disaster management, and agricultural assessment. However, the presence of clouds in optical satellite images often obstructs ground visibility, limiting their utility. To address this issue, various deep neural network-based approaches have been developed for cloud removal, aiming to reconstruct clear, cloud-free images from cloud-contaminated inputs.

Traditional cloud removal methods rely on single-modality input, such as optical images, and utilize convolutional neural networks (CNNs) to map the cloudy image to a reconstructed cloud-free output. While these methods achieve moderate success, they are often limited by the lack of structural information when clouds obscure significant portions of the image. As a result, fine details are frequently lost, and artifacts may be introduced during the reconstruction process.

To overcome these limitations, more advanced deep learning approaches have been introduced, incorporating conditional generative models, such as Conditional Generative Adversarial Networks (cGANs) and Conditional Diffusion Models (cDMs). These models aim to improve cloud removal by generating cloud-free images conditioned on additional input information, such as temporal image sequences or ancillary data sources such as Synthetic Aperture Radar (SAR). Conditional Diffusion Models, in particular, leverage iterative denoising processes starting from Gaussian noise, enabling more accurate reconstructions.

However, these approaches often struggle when clouds obscure large or complex areas and may fail to accurately reconstruct the underlying structures, especially in the absence of auxiliary data that provides additional spatial information.

Accordingly, there is still a need for methods that more accurately reconstruct cloud-free optical satellite images while preserving fine spectral and structural details, even in the presence of significant cloud cover.

### SUMMARY

The advancement of generative models has significantly improved satellite image restoration, particularly for cloud removal in optical imagery. Diffusion models (DMs) have emerged as a leading approach, leveraging forward and backward processes to iteratively add and remove Gaussian noise, enabling the generation of cloud-free images. While these models can be conditioned on cloudy optical images and additional data such as Synthetic Aperture Radar (SAR) images, the models often struggle with reconstructing fine scene details. SAR imaging, which penetrates cloud cover and provides structural information, complements optical images but introduces integration challenges within the DM framework.

To address these limitations, some embodiments use diffusion bridges (DBs) as a superior alternative to DM for cloud removal in optical image reconstruction. Unlike DMs, which start from Gaussian noise, DBs operate by modeling a direct transition between the cloudy and cloud-free states, refining the image iteratively rather than relying on stochastic sampling. This approach ensures a more stable and deterministic reconstruction, effectively preserving fine details and reducing over-smoothing. Optionally, some implementations add some noise in the reverse process at each step, to make the method stochastic. In any case, by treating the cloudy image as the initial state and the cloud-free image as the target distribution, DBs progressively remove cloud-induced noise only in the optical images or while integrating information from SAR imagery.

In addition, some embodiments disclose a multimodal diffusion bridge (DB) framework, which incorporates SAR images not merely as conditional inputs but as an additional modality guiding the structural recovery process. Using a two-branch backbone architecture, the system employs an Optical Image Restoration Branch and a SAR Feature Extraction Branch, interconnected through SAR Fusion Blocks (SFBlocks). These blocks leverage cross-attention mechanisms to efficiently fuse spectral details from optical images with structural insights from SAR data, enhancing reconstruction accuracy while maintaining computational efficiency.

In these embodiments, the transition from DMs to multimodal DBs represents a transformative advancement in satellite image restoration. By emphasizing structured noise removal and multimodal integration, this framework achieves superior fidelity in cloud-free image reconstruction. The combination of iterative refinement, cross-attention mechanisms, and efficient backbone design enables scalable and robust performance, setting new benchmarks in cloud removal technology.

### BRIEF DESCRIPTION OF THE DRAWINGS

FIG. 1 shows a schematic of transitioning from using diffusion models (DMs) to using diffusion bridge (DB) to iteratively reconstruct cloud-free image according to some embodiments.

FIG. 2 shows a schematic of a sequential process flow for generating a cloud-free optical satellite image using a diffusion bridge (DB) framework, in accordance with some embodiments.

FIG. 3 shows a block diagram of a method for generating a cloud-free optical satellite image from a cloudy optical satellite image using a diffusion bridge (DB) framework, in accordance with some embodiments.

FIG. 4 illustrates a block diagram of an embodiment of a system implementing a diffusion bridge (DB) framework for cloud removal in satellite imagery.

FIG. 5A and FIG. 5B shows pseudo-codes of exemplar training and execution stage of multimodal DB according to some embodiments.

FIG. 6A shows an image processing system for recovering an image with reduced extent of cloud cover, in accordance with some embodiments.

FIG. 6B shows a schematic of a two-branch architecture forming a multimodal reverse diffusion bridge process according to some embodiments.

FIG. 7A shows a block diagram of the time embedding block for the reverse diffusion bridge process according to some embodiments.

FIG. 7B shows a block diagram of the NAFBlock forming U-net architecture for image restoration SAR feature extraction branches according to some embodiments.

FIG. 8 shows a block diagram of a SAR Fusion Blocks (SFBlock) according to some embodiments.

FIG. 9 shows a block diagram depicting application of the multimodal DB framework employed for control tasks, according to some example embodiments.

FIG. 10 shows some components of a computer system implementing the image processing system for cloud removal according to some example embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, as understood by one of ordinary skill in the art, the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like-reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

### Overview of the Contribution to the Art

This Overview is provided to introduce a selection of concepts in a simplified form that are further described below in the Detailed Description. This Overview is not intended to identify key features or essential features of the claimed subject matter, nor is it intended to be used as an aid in determining the scope of the claimed subject matter.

The development of advanced generative models has significantly transformed satellite image restoration, particularly in addressing the challenge of cloud removal. Diffusion models (DMs), among the most promising approaches, leverage forward and backward processes that incrementally add and remove Gaussian noise, respectively. This dual training mechanism enables the models to reconstruct clean images, starting from pure Gaussian noise, while learning the underlying data distribution.

Certain innovations have emerged from the realization that diffusion models can be conditioned on other images. For example, diffusion models can be trained to generate cloud-free images starting from Gaussian noise, conditional on a corresponding cloudy image. More sophisticated embodiments extend this capability by incorporating additional data sources, such as Synthetic Aperture Radar (SAR) images. SAR imaging, known for its ability to penetrate clouds while providing structural data, complements optical images. In this case, the diffusion model not only relies on the cloudy optical image but also leverages SAR imagery to create cloud-free images with greater detail and accuracy. These conditional diffusion models (cDMs) represent the state of the art in cloud removal, particularly when assisted by SAR imaging. Despite success, conditional diffusion models often struggle with reconstructing fine scene details in cloud-free images, highlighting a limitation.

This deficiency stems from the inherent nature of DMs: their reliance on sampling from Gaussian noise. DMs are trained to remove pure Gaussian noise, which tends to bias the reconstruction process and limits the fidelity of fine details. Addressing this challenge, some embodiments are guided by the intuition-later supported by empirical evidence—that Diffusion Bridges (DBs) offer a superior solution. Unlike DMs, which sample from Gaussian noise, DBs directly utilize the distribution of the images. This shift in approach fundamentally changes how noise is treated during training and inference.

For instance, in a DB framework, the cloudy image serves as a representation of the input noise distribution, while the cloud-free image represents a target noise distribution. Rather than treating noise as a mere condition, the DB directly removes the noise iteratively from the cloudy image. This framework enables a deterministic transition between the initial (cloudy) state and the final (cloud-free) state. The DB operates by progressively refining the cloudy image through multiple iterations, integrating structural information from the SAR image and spectral details from the optical image. At each step, the reconstructed cloud-free image combines elements of the input cloudy image and the output of the previous iteration, incrementally emphasizing the cloud-free regions while retaining fine scene details.

The DB framework follows the principles of diffusion processes by iteratively recovering the cloud-free image over multiple time steps. This iterative process incorporates controlled updates that progressively reduce cloud cover, ultimately yielding a clear and detailed final image. The key difference lies in how noise is treated: rather than adding and removing pure Gaussian noise, DBs focus on refining the target noise distribution. This nuanced approach allows DBs to generate sharper and more accurate cloud-free images, overcoming the limitations of traditional cDMs.

In effect, the evolution from conditional diffusion models to diffusion bridges marks a transformative step in cloud removal technology. By adopting a target distribution for noise and emphasizing iterative refinement, DBs address the inherent deficiencies of cDMs. These advancements not only enhance reconstruction fidelity but also set new benchmarks for integrating multimodal data in satellite imagery restoration.

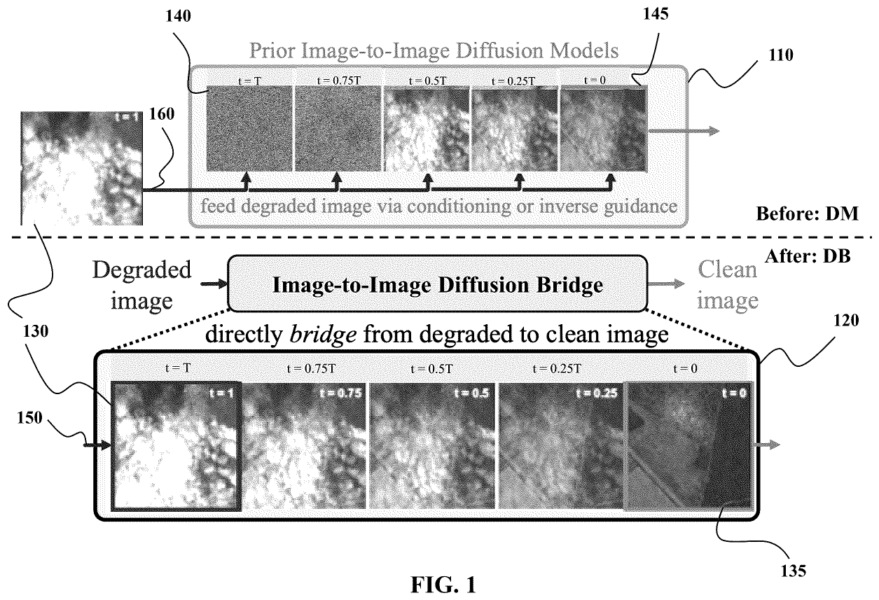

FIG. 1 shows a schematic of transitioning from using diffusion models (DMs) 110 to iteratively t=1, . . . 0, reconstruct the cloud-free image 145 from Gaussian noise 140 conditioned 160 on cloudy image 130 to using diffusion bridge (DB) 120 that process the cloudy image 130 directly by process 150 to iteratively reconstruct the image 130 into the target cloud-free image 135 through an iteration of the reverse DB steps according to some embodiments.

### Conditional Diffusion Models for Image Restoration

Specifically, the Conditional Diffusion Models (cDM) are designed to learn a parameterized Markov chain to convert a Gaussian distribution into a conditional data distribution p(x|c). The cDM-based methods have shown great performance in cloud removal task with or without assistance from radar image, such as SAR image. In the cloud-removal task, x refers to the target cloud-free optical image, and the condition c refers to the combination of the corresponding cloudy image and/or SAR image. The forward diffusion process starts from a clean sample x₀ x~p(x), then gradually adds Gaussian noise to x₀ according to the following transition probability:

$$q ( {x}_{t} \vert {x}_{t - 1} ) := 𝒩 ( {x}_{t} ; \sqrt{1 - {β}_{t}} {x}_{t - 1} , {β}_{t} I ) , \qquad ( 1 )$$

where t ∈ [0, T], [symbol] (x; μ, Σ) denotes the Gaussian probability density function (pdf) over x with mean μ and covariance matrix Σ, and βₜ is the noise schedule of the process. By the parameter changes αₜ: =1−βₜ and

$${\overline{α}}_{t} := {\prod }_{s = 1}^{t} {α}_{s} , {x}_{t}$$

is rewritten as a linear combination of ϵₜ and x₀:

$${x}_{t} = \sqrt{{\overline{α}}_{t}} {x}_{0} + \sqrt{1 - {\overline{α}}_{t}} {ϵ}_{t} , \qquad ( 2 )$$

where ϵₜ~ [symbol] (0, I). This yields a closed-form expression for the marginal distribution of xₜ given x₀, which simplifies sampling across multiple steps of the Markov chain:

$$q ( {x}_{t} \vert {x}_{0} ) := 𝒩 ( {x}_{t} ; \sqrt{{\overline{α}}_{t}} {x}_{0} , ( 1 - {\overline{α}}_{t} ) I ) . \qquad ( 3 )$$

The goal of the reverse process is to generate a clean image x₀ given a pure Gaussian noise image x_{T} 140 and the condition c 130. This is achieved by training a neural network 110 δ_{θ}, parameterized by θ, to reverse the Markov Chain from x_{T} to x₀ one step at a time. The learning is formulated as the estimation of a parameterized Gaussian process

$$p ( {x}_{t - 1} \vert {x}_{t} ) := 𝒩 ( {x}_{t - 1} ; {μ}_{θ} ( {x}_{t} , t , c ) , {σ}_{t}^{2} I ) , \qquad ( 4 )$$

where the mean μ_{θ}(xₜ, t, c) is only variable that is to be estimated, and

$${σ}_{t}^{2} = \frac{1 - {\overline{α}}_{t}}{1 - {\overline{α}}_{t - 1}} {β}_{t} .$$

In cDM, ϵ_{θ} is trained to predict the noise ϵₜ added during the forward process by minimizing the following expected loss:

$$\begin{matrix}a . & \\ ℒ ( θ ) = {𝔼}_{{ϵ}_{t} , {x}_{t} , t} [ {‖ {ϵ}_{θ} ( {x}_{t} , t , c ) - {ϵ}_{t} ‖}_{2}^{2} ] . & ( 5 )\end{matrix}$$

The estimated noise is then used to reparameterize the sampling from the conditional distribution:

$${x}_{t - 1} = \frac{1}{\sqrt{{α}_{t}}} ( {x}_{t} - \frac{{β}_{t}}{\sqrt{1 - {\overline{α}}_{t}}} {ϵ}_{θ} ( {x}_{t} , t , c ) ) + {σ}_{t} z , \qquad ( 6 )$$

where z~ [symbol] (0, I). By iteratively applying this reverse process from t=T to t=0, the trained cDM reconstructs the clean sample x₀ by progressively sampling from the learned conditional distribution.

Some embodiments are based on recognition that cDMs can be used to address cloud removal tasks, leveraging the power of diffusion models to produce high-quality cloud-free images. However, despite promising results, the stochastic nature of the reverse process sometimes lead to inconsistencies and artifacts in the image 145, especially in areas where the model needs to be more precise in reconstructing details.

This motivated various embodiments to consider the use of more deterministic approaches. In particular, the embodiments focus on the diffusion bridge framework 120. In this approach, the diffusion bridge explicitly controls the transformation between the cloudy image 130 and cloud-free image 135, providing a more stable and effective solution to the cloud removal problem.

### Overview of Diffusion Bridges for Image Restoration

Generation in DMs is achieved by transforming noise into a target distribution through a series of denoising steps. The diffusion bridge (DB) method generalizes this approach by modeling a stochastic process that connects two fixed states, where the initial state is not limited to a Gaussian distribution. In the context of image restoration, DBs generally involves constructing a probabilistic trajectory between two states (e.g., degraded and clean images) using an optimal transport formulation. This approach leverages the inherent similarity between these states to efficiently learn mappings, leading to improved performance and faster inference.

For example, a diffusion bridge explicitly models the transition from a degraded image state to a clean image state through an Optimal Transport (OT) framework. Give a tuple (x₀, y)~p(x, y), where y represents the degraded image and x₀ represents the target clean image, the forward process in DB begins from x₀ and transforms x₀ towards y, with each intermediate state xₜ representing a linear mixture of both the corrupted and target images. This process is defined as:

$${x}_{t} = ( 1 - {α}_{t} ) {x}_{0} + {α}_{t} y , {α}_{t} ∈ [ 0 , 1 ] , \qquad ( 7 )$$

where αₜ is a monotonically increasing function as t goes from 0 to T.

Specifically, α₀=0 and α_{T}=1. As t progresses from 0 to T in the forward process, xₜ transitions smoothly from the clean image x₀ to the degraded image y, creating a well-defined trajectory that deterministically blends the two image states. Conversely, in the reverse process, as t progresses from T to 0, xₜ evolves from y back to x₀ through a deterministic trajectory, progressively removing the degradation and reconstructing the original clean image.

The reverse process in the DB framework reconstructs the clean image from the degraded observation through a multi-step sampling strategy, utilizing an Optimal Transport Ordinary Differential Equation (OT-ODE). Unlike traditional end-to-end cloud removal models that attempt to estimate a clean image in a single pass, the Diffusion Bridge breaks down the transformation into a sequence of smaller, more manageable steps, each guided by the OT-ODE. The OT-ODE is described by:

$$\frac{{dx}_{t}}{dt} = {v}_{t} ( {x}_{t} \vert {x}_{0} ) , where {v}_{t} ( {x}_{t} \vert {x}_{0} ) = {α}_{t} ( {x}_{0} - {x}_{t} ) , \qquad ( 8 )$$

where vₜ(xₜ|x₀) represents the optimal velocity field that guides xₜ towards the target state x₀. To approximate this velocity field, a neural network R_{θ}(xₜ, t) is trained to determine the optimal direction for each step of the reverse evolution. The training objective for the network is formulated as:

$${θ}^{*} = {arg min}_{θ} {𝔼}_{t , {x}_{t} , {x}_{0}} [ {‖ {D}_{θ} ( {x}_{t} , t ) - {v}_{t} ( {x}_{t} \vert {x}_{0} ) ‖}_{2}^{2} ] , \qquad ( 9 )$$

where D_{θ}(xₜ, t) predicts the optimal velocity that guides xₜ back to the clean target state x₀. The multi-step reverse sampling provides incremental updates toward the optimal transport solution, minimizing transport costs and preserving structural details. The controlled velocity at each stage ensures a smooth transition, reducing artifacts and oversmoothing, which are commonly observed in ill-posed problems. By decomposing the reconstruction into multiple steps, the diffusion bridge framework addresses the complexity of difficult restoration tasks by solving progressively simpler sub-problems, showing state-of-the-art performance in various image restoration tasks (e.g., image super-resolution, image deblurring, and image inpainting).

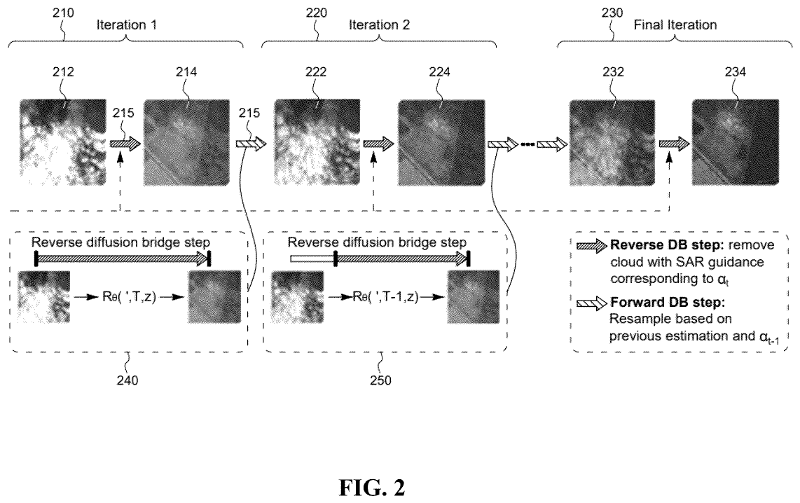

FIG. 2 shows a schematic of a sequential process flow for generating a cloud-free optical satellite image using a diffusion bridge (DB) framework, in accordance with some embodiments. This process outlines the structured steps involved in transforming a cloudy optical satellite image into a cloud-free counterpart through an iterative reverse diffusion bridge process across iterations 210, 220, and 230.

The DB framework begins by receiving a cloudy optical satellite image 212, which serves as the initial degraded state for the diffusion bridge process during the first iteration 210. Next, the DB framework iteratively applies a reverse diffusion bridge process 210, 220, 230 to progressively refine the image. The model operates iteratively, transitioning the image from a cloudy state to a refined, cloud-free state. For instance, during iteration 210, cloudy image 212 is processed by reverse diffusion process 240 to generate an intermediate cloud-free image 214. During iteration 220, the intermediate cloudy image 222 is further refined by reverse diffusion bridge process 250 into intermediate image 224. During iteration 230, the intermediate cloudy image 232 undergoes a final transformation into the cloud-free image 234.

Unlike diffusion models (DMs) that rely on starting the reverse process by sampling from Gaussian noise, the DB framework directly models the progressive refinement of image data, ensuring a stable and controlled transition from the cloudy to the cloud-free state. At each iteration, the reverse diffusion bridge process enhances the image by progressively reducing cloud-induced noise while maintaining structural consistency, thereby preserving fine details. To generate the intermediate cloudy image for a subsequent iteration, the DB framework combines the previous iteration's intermediate cloudy image with the corresponding intermediate cloud-free image. For example:

To produce the intermediate cloudy image 222, the framework combines the images 212 and 214. This combination process is iteratively repeated throughout different iterations, effectively acting as a noisy weighted average, wherein the weighting gradually shifts toward favoring the cloud-free image as the process progresses.

By leveraging a structured transition between the cloudy and cloud-free states, the diffusion bridge framework overcomes key limitations of traditional conditional diffusion models (cDMs), offering a more robust, accurate, and computationally efficient solution for cloud removal in satellite imagery.

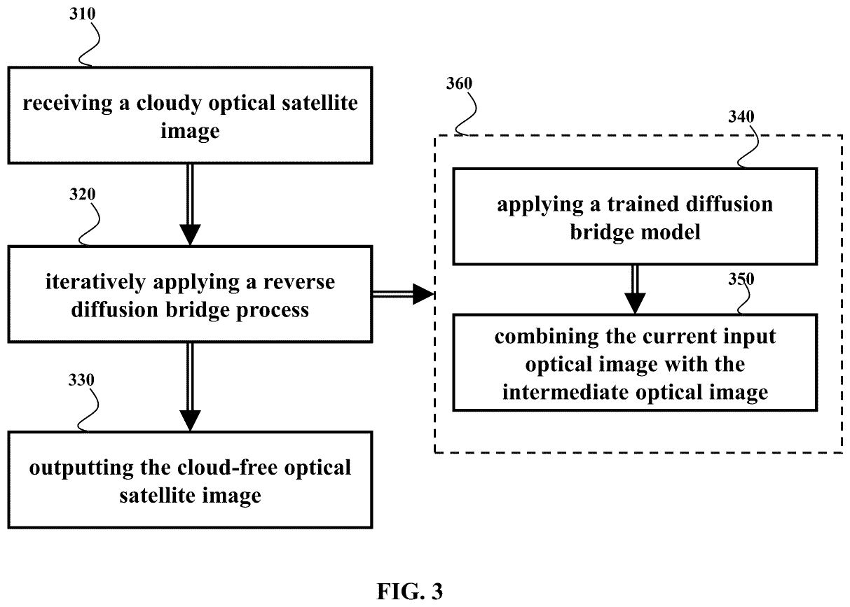

FIG. 3 shows a block diagram of a method for generating a cloud-free optical satellite image from a cloudy optical satellite image using a diffusion bridge (DB) framework, in accordance with some embodiments. The method is executed by a processor configured with stored instructions, wherein the instructions, when executed, iteratively refine the input image through a structured reverse diffusion bridge process.

The method begins by receiving an input optical satellite image 310 that contains cloud cover. This image serves as the starting degraded state for processing within the diffusion bridge framework. Next, the method is iteratively applying a reverse diffusion bridge process 320. In such manner, the diffusion bridge model iteratively transitions the image from its cloudy state to its cloud-free state over a sequence of one or more time steps. The reverse diffusion bridge process progressively refines the image while preserving structural integrity and minimizing cloud-induced distortions.

Each iteration 360 of the iterative image refinement using the reverse diffusion bridge process, until a termination condition is met, includes at least two steps for generating 340 an intermediate optical image with reduced cloud-induced noise and combining 350 the current intermediate cloudy image with the recovered. In such a manner, the model applies a trained diffusion bridge process to refine the input image at each step, progressively reducing cloud artifacts. The intermediate output from the previous step is combined with the image from the current iteration, ensuring a gradual and controlled transition toward a high-fidelity cloud-free image.

After sufficient iterations, the process generates and outputs 330 a reconstructed cloud-free optical satellite image, which has undergone progressive refinement through multiple diffusion bridge steps.

By leveraging structured iterative refinement, the diffusion bridge framework overcomes the limitations of traditional conditional diffusion models (cDMs). The method ensures a controlled, deterministic transition between the cloudy input state and the final cloud-free state, producing a high-fidelity restored image suitable for applications such as environmental monitoring, agricultural assessment, and disaster response.

In general, the diffusion bridge model is trained to iteratively recover a cloud-free optical satellite image by modeling a deterministic transition between an initial cloudy image distribution and a target cloud-free image distribution. Unlike diffusion models that rely on stochastic sampling from Gaussian noise, the diffusion bridge framework establishes a structured transformation process that progressively refines the image while maintaining fidelity to the underlying scene.

In some embodiments, the training process employs both a forward process and a reverse process to optimize the transition between the cloudy and cloud-free states. The forward process involves constructing a representation of the target cloud-free image distribution by combining the cloudy optical satellite image and the cloud-free optical image at each time step. This combination ensures that the model learns an appropriate trajectory for transforming a degraded image into its clean counterpart.

The reverse process then iteratively refines the cloudy optical image by progressively removing cloud-induced noise at each time step. Unlike conditional diffusion models (cDMs), which introduce randomness in their sampling, the diffusion bridge models a deterministic trajectory from the cloudy image distribution to the cloud-free image distribution. This approach ensures a stable and controlled transformation, effectively minimizing artifacts and over-smoothing.

To optimize this transformation, some embodiments minimize a loss function that quantifies the difference between the predicted cloud-free optical image and a ground-truth cloud-free optical image. By iteratively refining the reconstruction at each step, the diffusion bridge framework enhances the structural integrity and spectral accuracy of the final cloud-free image, achieving superior performance in cloud removal applications compared to traditional stochastic methods.

### Multimodal Diffusion Bridges

Building upon the evolution from conditional diffusion models (DMs) to diffusion bridges (DBs), some embodiments of the disclosure recognize the unique value of incorporating Synthetic Aperture Radar (SAR) images to enhance both approaches. SAR data, with its ability to penetrate clouds and capture structural information, complements optical images, which provide rich spectral details but are highly sensitive to cloud occlusion. However, the integration of SAR into DB frameworks introduces distinct challenges and opportunities, paving the way for a novel multimodal diffusion bridge (DB) architecture.

The conditional DMs sample from Gaussian noise and treat SAR and optical images similarly as conditions. This design allows straightforward integration of both modalities into the sampling process. However, DBs operate differently. Rather than starting from Gaussian noise, DBs directly model the noise distribution over the cloudy image, creating a deterministic transition from the cloudy to the cloud-free state. This fundamental difference means the SAR image cannot be used as a condition in the same manner as the cloudy optical image. Instead, SAR is treated as an additional input modality, necessitating a rethinking of how SAR's structural information is incorporated into the process. To overcome this challenge, some embodiments use a multimodal DB framework, where the SAR image is treated as a complementary input modality that guides the structural recovery of the cloud-free optical image.

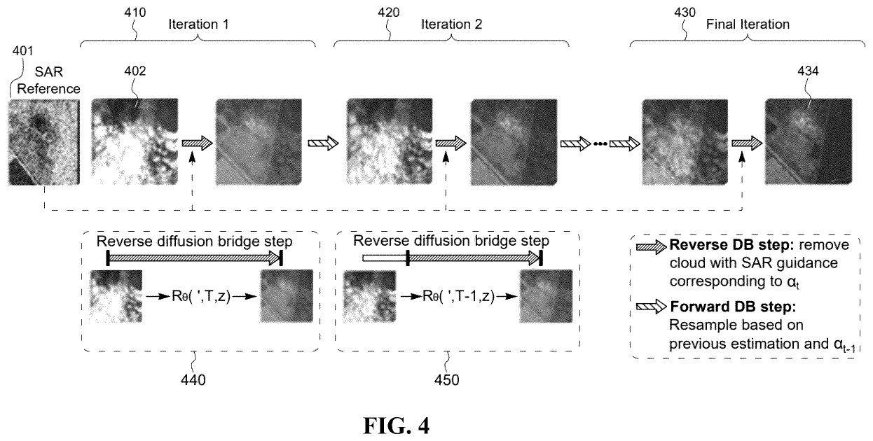

FIG. 4 illustrates a block diagram of an embodiment of a system implementing a diffusion bridge (DB) framework for cloud removal in satellite imagery. In this embodiment, the system integrates Synthetic Aperture Radar (SAR) imagery to enhance the structural recovery of a cloud-free optical satellite image through an iterative reverse diffusion bridge process.

The system receives two spatially aligned input images: a Synthetic Aperture Radar (SAR) image 401, which provides structural information that penetrates cloud cover, and a cloudy optical satellite image 402, which serves as the primary input for cloud removal processing. The SAR image 401 acts as a complementary data source to guide the recovery process, improving the structural accuracy of the reconstructed cloud-free image.

The reverse diffusion bridge process is applied iteratively 410, 420, 430 to refine the optical image while leveraging SAR-based structural guidance. The initial processing step 410 incorporates SAR information into the diffusion bridge model to provide structural constraints, ensuring that the cloud removal process preserves spatial features. The model progressively at step/iteration 420 refines the image by reducing cloud-induced noise while aligning with the structural information provided by the SAR image. The final iteration 430 outputs a cloud-free optical satellite image 434, preserving both spectral and structural details.

In contrast to the single mode DB process, the reverse diffusion process 440 and 450 use SAR-Guided structural recovery. During each iteration, the intermediate images undergo a fusion process where the cloudy optical image and the SAR image are jointly processed to iteratively refine structural details. The combination step progressively reduces cloud artifacts while enhancing fine details, ensuring that the final image reconstruction is both spectrally and spatially accurate.

After multiple reverse diffusion bridge iterations, the system generates and outputs a cloud-free optical satellite image 434, optimized for various applications such as remote sensing, environmental monitoring, and disaster assessment.

By leveraging SAR as a guiding modality, this embodiment overcomes the limitations of purely optical cloud removal techniques. The multimodal integration approach ensures that the diffusion bridge process maintains both fine spectral details and structural integrity, offering state-of-the-art performance in satellite image restoration.

In some embodiments, the integration of SAR into the DB is achieved using a cross-attention mechanism, which aligns and fuses features from the SAR and optical images at multiple levels during the iterative reverse diffusion bridge process. Cross-attention offers a multimodal alternative to self-attention by selectively focusing on relevant features from the SAR image, where queries are derived from the optical image features and keys and values are derived from the SAR image features. By concentrating solely on the interaction between SAR and optical features, cross-attention reduces computational complexity from O(h²w²), which depends on spatial dimensions (h and w), to O (c²), which depends on the number of channels (c). This efficiency is achieved by compressing spatial information into channel dimensions, making the architecture scalable for processing large satellite images.

To that end, some embodiments disclose the SAR-conditioned cloud removal problem. The objective is to generate a cloud-free optical satellite image, x ∈ [symbol] ^{C,H,W}, from a single observed cloudy optical image, y ∈ [symbol] ^{C,H,W}, and the corresponding SAR image z E [symbol] ^{C′,H,W}. In some embodiments, C=13 is the number of multispectral channels in each optical image, C′=2 is the number of channels in the SAR image, and H and W are the images' height and width, respectively.

### Multimodal Diffusion Bridge Framework for Cloud Removal (DB-CR)

Given a pair of spatially aligned optical images, one cloudy and one cloud-free, the processor defines the forward process of the diffusion bridge (DB) at each discrete time step as

$${x}_{t} = ( 1 - {α}_{t} ) {x}_{0} + {α}_{t} y , t ∈ \{ 0 , 1 , ... , T \} , \qquad ( 10 )$$

where xₜ represents an intermediate image transitioning from the cloud-free image x (at t=0) to the cloudy image y (at t=T). The weighting factor at is a function that increases monotonically from 0 to 1 as t goes from 0 to T, ensuring a smooth and deterministic trajectory between the two image states.

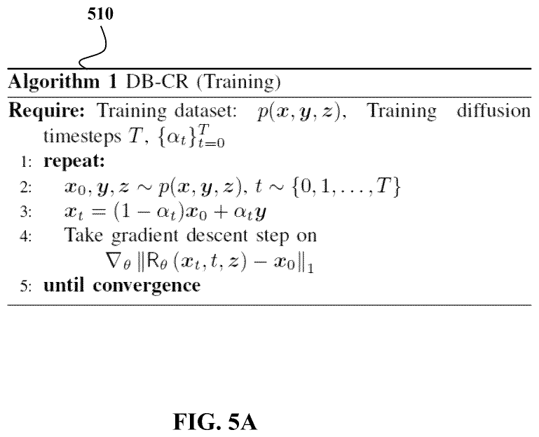

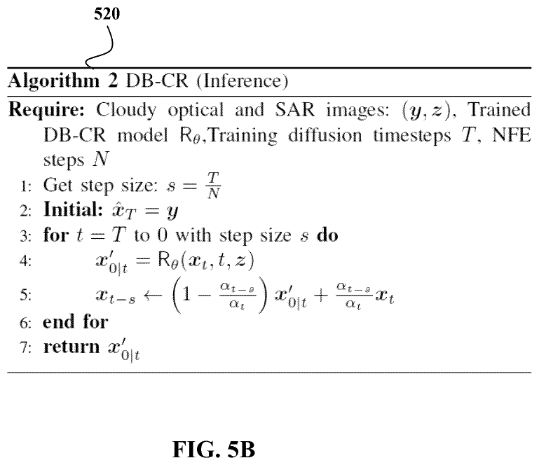

The reverse process aims to recover the clean image x from the cloudy image y by inverting this DB forward process. To accomplish this, a neural network [symbol] _{θ} is trained to predict the clean image at each time step t, given the corrupted intermediate image xₜ and the aligned SAR reference image z. The training objective is defined as:

$${θ}^{*} = {arg min}_{θ} {𝔼}_{t ∼ \{ 0 , 1 , ... , T \}} {‖ {R}_{θ} ( {x}_{t} , t , z ) - {x}_{0} ‖}_{1} , \qquad ( 11 )$$

where the model directly learns to predict x₀ at each time step. Here, the mean absolute error (MAE) loss function is used, which has demonstrated good performance for the cloud removal task. In this formulation, R_{θ} learns to predict the minimum mean absolute error (MMAE) estimation, [symbol] [x₀|xₜ], of true cloud-free image x₀ from the intermediate corrupted input xₜ. The pseudocode 510 for this training process is provided in FIG. 5A.

Once the network is trained, the embodiments define a reverse process to reconstruct the cloud-free image x₀ from the cloudy observation x_{T}. As t is decreased from T (initial step) to 0 (final step), αₜ progressively decreases from 1 to 0, and the reverse process incrementally refines the image, transforming x_{T} back to x₀.

Given a predefined number of function evaluations (NFE), some embodiments uniformly select N timesteps from the original diffusion process, by setting an appropriate step size s. Following this schedule of diffusion timesteps, the process starts with the original cloudy image y as the initial input and iteratively transforms initial input toward a cloud-free state. At each iteration, the pre-trained model Re computes the cloud-free estimate x_{0|t′} based on the current intermediate image xₜ, time step t, and auxiliary SAR data z. Using Equation (12), the next intermediate image xₜ₋₁ is resampled by combining x_{0|t′} with xₜ.

$${x}_{t - s} = ( 1 - \frac{{α}_{t - s}}{{α}_{t}} ) {x}_{0 \vert t}^{′} + ( \frac{{α}_{t - s}}{{α}_{t}} ) {x}_{t} , s < t , \qquad ( 12 )$$

where s is the step size of the reverse process and x_{0|t′} represents the cloud-free prediction based on the intermediate image xₜ, i.e., x_{0|t′}= [symbol] [x₀|xₜ]. The overall inference pseudocode 520 is given in FIG. 5B. This repeated resampling progressively reduces cloud cover, ultimately producing the final cloud-free image.

The multi-step generation approach effectively addresses the challenge of over-smoothing, which is common in ill-posed problems like cloud removal. Unlike single-step methods that directly estimate cloud-free images and often produce averaged outputs lacking fine details, this approach decomposes the task into a series of simpler sub-problems under a diffusion bridge formulation. At each step, the model incrementally refines a less degraded image, progressively removing the cloud cover. This iterative refinement not only mitigates over-smoothing but also preserves finer details. Additionally, the stepwise process allows for more effective integration of SAR information at each stage, leading to sharper and more accurate cloud-free reconstructions.

### Multimodal Diffusion Bridge Employs a Two-Branch Backbone

To fully leverage the strengths of both modalities, the multimodal diffusion bridge employs a two-branch backbone consisting of an Optical Image Restoration Branch and a SAR Feature Extraction Branch. The Optical Image Restoration Branch utilizes a U-Net-based architecture with Nonlinear Activation-Free (NAF) blocks to refine the optical image and recover fine spectral details, while the SAR Feature Extraction Branch operates as a parallel encoder architecture dedicated to extracting structural features from the SAR image. These branches are interconnected through SAR Fusion Blocks (SFBlocks), which integrate a cross-attention mechanism to enable efficient multimodal feature fusion. The SFBlocks align and merge the structural information from the SAR image with the spectral details from the optical image, ensuring accurate and robust reconstruction of cloud-free optical images.

The multimodal diffusion bridge framework refines the cloudy optical image iteratively over multiple time steps by leveraging a structured reverse diffusion process. At each iteration, the optical and SAR features are fused using cross-attention within the SAR Fusion Blocks, effectively combining the spectral richness of the optical image with the structural guidance from the SAR data. The fused features guide the generation of a partially restored optical image, progressively reducing cloud cover while recovering fine details. This iterative refinement process culminates in a high-fidelity cloud-free optical image that seamlessly integrates the complementary strengths of both modalities.

The multimodal diffusion bridge framework effectively addresses key limitations of existing diffusion-based methods, particularly in integrating multimodal data for cloud removal. By treating SAR as an additional input modality rather than a condition, this approach maximizes the utilization of SAR's structural information while maintaining computational efficiency. The incorporation of cross-attention for feature fusion not only enhances reconstruction accuracy but also minimizes computational overhead, making the framework highly scalable for processing large-scale satellite imagery. The two-branch architecture and iterative refinement process fully leverage the complementary strengths of SAR and optical modalities, producing cloud-free optical images with superior fidelity and detail. This innovative framework sets a new benchmark in cloud removal technology, providing a robust and scalable solution for multimodal image restoration in satellite imagery and other applications.

In effect, this approach transforms how SAR images are used in diffusion-based frameworks. By leveraging SAR as a structural guide within a multimodal DB, this technology not only enhances the fidelity of the reconstructed cloud-free optical images but also establishes a scalable and robust solution for multimodal image restoration challenges.

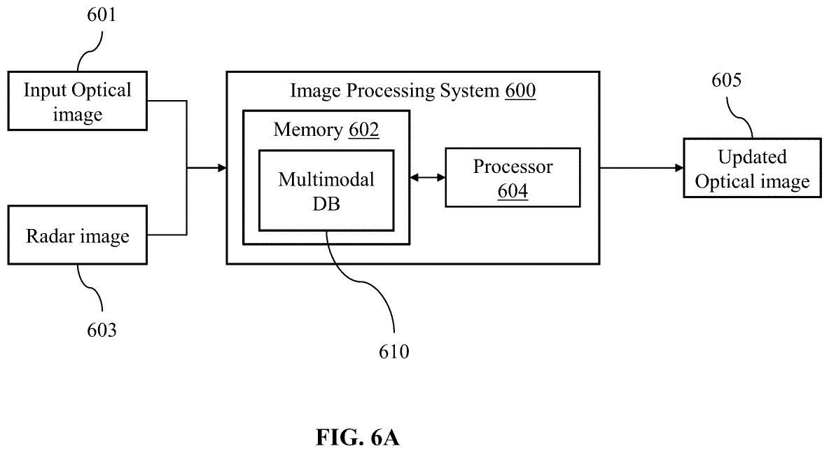

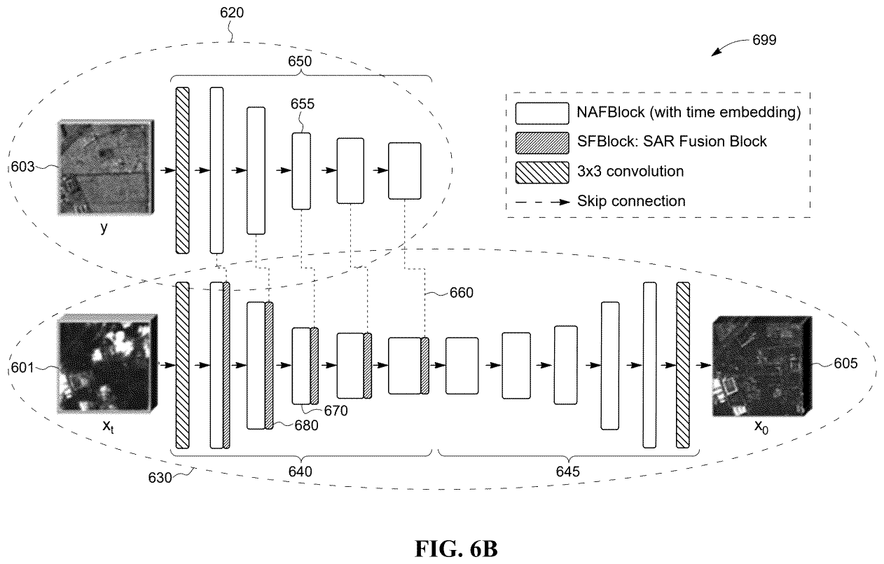

FIG. 6A shows an image processing system 600 for recovering an image with reduced extent of cloud cover (also referred to as cloudless image 605 or updated optical image 605) from an aligned pair of an optical image 601 and a radar image, e.g., SAR image 603 of a scene, in accordance with some embodiments. The image processing system 600 may be embodied as a computing apparatus comprising a memory 602 and one or more processors 604 (hereinafter, also referred to as a processor). The processor 604 reads data and program from the memory 602 to perform the recovery of cloudless images.

The memory stores amongst other things, a multimodal DB 610 that is trained to reduce the extent of cloud cover in the input provided to it. In this regard, the multimodal DB 610 is configured to process the SAR image 603 in parallel with the cloudy optical satellite image 601 using a two-branch architecture forming a multimodal reverse diffusion bridge process. For example, the two-branch architecture includes an optical image restoration branch configured to refine the optical image 601 and recover fine spectral details; and a SAR feature extraction branch configured to extract structural features from the SAR image 603 to guide the recovery process.

FIG. 6B shows a schematic of a two-branch architecture 699 forming a multimodal reverse diffusion bridge process according to some embodiments. The optical image restoration branch 630 includes a U-Net-based architecture including an encoder path 640 that extracts hierarchical features from the cloudy optical satellite image 601 and a decoder path 645 that reconstructs the cloud-free optical satellite image 605.

The SAR feature extraction branch 620 includes an encoder path 650 corresponding to the encoder 640 of the optical image restoration branch 630, configured to extract structural features from the SAR image at resolutions matching those of the optical image encoder 640. In such a manner, the encoder path 640 and 650 extract hierarchical features from the cloudy optical satellite image 601 and the SAR image 603, respectfully, while the decoder path 645 reconstructs the cloud-free optical satellite image from the extracted features.

The U-Net-based architecture configured to refine the cloudy optical satellite image also includes skip connections 660 between corresponding levels 655 and 670 of the encoders 650 and 640, and/or between the corresponding levels of the encoder and decoder paths to preserve fine spectral details during the iterative reverse diffusion bridge process.

In addition, some embodiments applies a cross-attention mechanism 680 at each corresponding resolution of the optical image encoder and the SAR encoder, such that queries are derived from the features of the optical image encoder, while keys and values are derived from the features of the SAR encoder.

### SAR-Enhanced Diffusion Bridge Backbone

In some implementations, the architecture 699 is forming a two-branch diffusion bridge backbone, consisting of a SAR feature extraction branch and an optical image restoration branch. The backbone is built using two main components: (1) a time-embedded Nonlinear Activation-Free Network (NAFNet) block, e.g., block 655 and 670, and (2) a cross-attention based SAR Fusion Block (SFBlock), e.g., the block 680. The SFBlock enables multi-level fusion of features from both the SAR extraction branch and the optical image restoration branch.

The disclosed DB-CR backbone has two branches: a NAFNet-based U-net architecture for image restoration 630 and a NAFNet encoder architecture for SAR feature extraction 620. This dual-branch design enables dedicated feature extraction for each modality, allowing the network to more efficiently learn modality-specific features.

To further increase efficiency of the DB-CR backbone, some embodiments incorporate Nonlinear Activation-Free Blocks (NAFBlocks) as a more efficient alternative to the ResBlock backbone. Some embodiments are based on recognizing that the diffusion bridge frameworks for image restoration, generally, employs a ResBlock backbone that combines residual and attention blocks to enhance feature representation. However, this setup can be computationally expensive due to the added complexity of attention mechanisms and activation layers. In contrast, NAFBlocks take a streamlined approach by excluding attention mechanisms and activation functions, focusing solely on linear transformations, which significantly reduces the computational overhead.

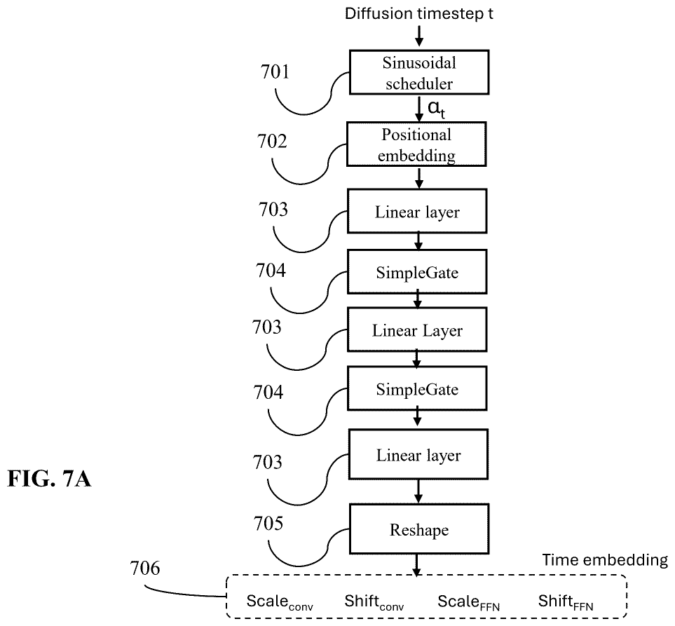

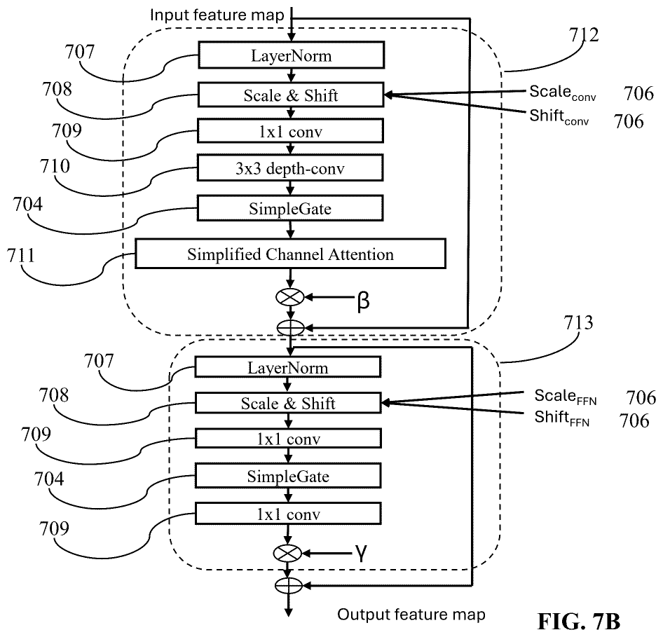

FIG. 7A shows a block diagram of the time embedding module according to some embodiments. Given a diffusion timestep t and the total time steps T, the diffusion time step t is first converted to a weight at using the sinusoidal scheduling function 701.

$${α}_{t} = sin ( \frac{π t}{2 T} )$$

Then, at is converted to a sinusoidal positional embedding 702 and passed through a feed forward network with 3 linear layers 703 and SimpleGates 704 in between each pair of linear layers. The output of the final layer is reshaped 705 into the output time embedding. The time embedding consists of 4 vectors each of dimension c that are denoted as Scale_{conv}, Shift_{conv}, Scale_{FFN} and Shift_{FFN} 706.

FIG. 7B shows a block diagram of the NAFBlock forming U-net architecture for image restoration SAR feature extraction branches according to some embodiments. In these embodiments, the NAFBlocks includes SimpleGate 704 units to replace nonlinear activation functions (such as ReLU or GELU). Given an input feature map X ∈ [symbol] ^{H×W×C}, SimpleGate 704 first splits the input into two features X₁, X₂ ∈ [symbol] ^{H×W×C/2} along the channel dimension. It then computes the output using element-wise multiplicative gating:

$$SimpleGate ( X ) = {X}_{1} ⊙ {X}_{2} \qquad ( 13 )$$

Each NAFBlock also contains a Simplified Channel Attention layer 711 defined as follows. Given an input feature X, and a pooling function that pools over the spatial dimensions H, W of the feature, the output of a Simplified Channel Attention (SCA) layer 711 is given by

$$SCA ( X ) = X \text{?} w * pool ( X ) , \qquad ( 13 )$$

Where [symbol] is a channel-wise product and w ∈ [symbol] ^{C}.

Each NAFBlock includes at least two parts:
(1) a mobile convolution module (MBConv) 712 consisting of a sequence of 1×1 convolution layer 709, scaling and shifting (SaS) layer 708, 3x3 depth-wise convolution layer 710, a SimpleGate 704 and a simplified channel attention (SCA) layer 711, and
(2) a feed-forward network (FFN) module 713 consists of a sequence of a 1×1 convolution layer 709, a scaling and shifting (SaS) layer 708, a SimpleGate 704 and another 1×1 convolution layer 709.

For the scaling and shifting layer in the MBConv module 712, for a feature map X with c channels

$${X}_{SaS} = SaS ( X , {Scale}_{conv} , {Shift}_{conv} ) = X * {Scale}_{conv} + {Shift}_{conv}$$

For the scaling and shifting layer in the FFN module 713, for a feature map X with c channels

$${X}_{SaS} = SaS ( X , {Scale}_{FFN} , {Shift}_{FFN} ) = X * {Scale}_{FFN} + {Shift}_{FFN}$$

A LayerNorm (LN) layer 707, which normalizes each feature map by subtracting the mean of all the elements in the feature map and dividing by the standard deviation of all the elements in the feature map, is added at the beginning of both MBConv and FFN modules. Finally, the feature maps are multiplied by learnable scalar parameters (β for MbConv, γ for the FFN module) and added to the input of the respective module via a residual connection to form the output of the module. The intermediate feature maps are denoted as Z_{MBConv} and Z_{FFN}. For a input feature map X, the whole process is formulated as:

$${Z}_{MBConv} = β * MBConv ( SaS ( LN ( X ) , {Scale}_{conv} , {Shift}_{conv} ) ) + X \qquad ( 14 )$$

$${Z}_{FFN} = γ * FFN ( SaS ( LN ( {Z}_{MBConv} ) , {Scale}_{FFN} , {Shift}_{FFN} ) ) + {Z}_{MBConv}$$

While NAFBlocks were originally designed for general RGB image restoration, NAFBlocks ability to streamline feature extraction without sacrificing performance makes them particularly suitable for our multi-spectral cloud removal task. By introducing the NAFBlocks, the reliance on heavy attention mechanisms and activation functions is reduced, achieving a balance between efficiency and accuracy in cloud-free image prediction. This high-efficiency block addresses the fundamental challenge of high computational demand in multi-step restoration, which is needed in diffusion bridges, resulting in faster inference while preserving image quality.

### SAR-Image Cross-Modal Attention Fusion

In some embodiments, the SAR Fusion Blocks 680 employ a cross-attention mechanism, wherein queries are derived from the features of the cloudy optical satellite image, and keys and values are derived from the features of the SAR image, enabling the structural information from the SAR image to guide the reconstruction of the cloud-free optical satellite image. In such a manner, the cross-attention mechanism 680 reduces computational complexity by compressing spatial dimensions into channel dimensions.

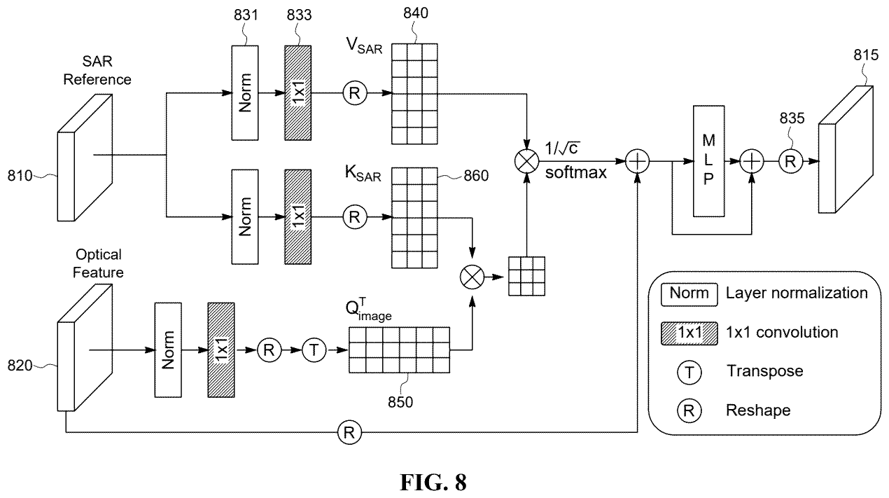

FIG. 8 shows a block diagram of a SAR Fusion Blocks (SFBlock) according to some embodiments. This block uses multi-head cross-attention to enable the model to capture the complementary nature of SAR and optical data by aligning and integrating features at multiple levels. SAR data, which is robust to atmospheric conditions, provides structural and texture information, while the optical data contributes color and fine details. By employing multi-head cross-attention between these modalities, the SFBlock ensures that the final reconstruction 815 benefits from the strengths of both data sources, ultimately leading to improved cloud removal and image restoration performance.

The SFBlock operates by applying a cross-modal attention mechanism similar to self-attention but with a key difference: the queries (Q_{O}) 850 are derived from the optical image 820 on optical image branch, while the keys (K_{S}) 860 and values (V_{S}) 840 come from the SAR image 810 on the SAR branch. In this setup, h and w represent the height and width of the feature maps, and c denotes the number of channels. Initially, both input features have dimensions h×w×c, but after passing through normalization 831 and 1×1 convolution layers 833, they are reshaped 835 to hw×c, where hw represents the flattened spatial dimensions.

The cross-modal attention mechanism selectively emphasizes relevant SAR features using guidance from the optical image content, leveraging the unique characteristics of each modality. For each attention head, this process is expressed as:

$$\begin{matrix}a . & \\ Attention ( {Q}_{O} , {K}_{S} , {V}_{S} ) = {V}_{S} \cdot soft max ( \frac{{Q}_{O}^{T} {K}_{S}}{\sqrt{c}} ) , & ( 15 )\end{matrix}$$

where

$${Q}_{O}^{T} {K}_{S} ∈ {ℝ}^{c \times c}$$

represents the similarity scores between optical and SAR features. These scores are computed by taking the transpose of the queries,

$${Q}_{O}^{T}$$

(dimension c×nw), and multiplying it by K_{S} (dimension hw×c), yielding a matrix in [symbol] ^{c×c} The resulting attention map in [symbol] ^{c×c} is then applied to Vs (dimension hw×c) to produce the final attended features in [symbol] ^{hw×c}. This channel-wise attention significantly reduces spatial complexity from O(h²w²) to O(c²), making the operation more efficient without sacrificing performance. Finally, the output of the attention operation is added to the input image features to produce Zₛᵤₘ, which is subsequently passed through a residual-connected multi-layer perceptron (MLP):

$${Z}_{output} = {Z}_{sum} + MLP ( {Z}_{sum} ) . \qquad ( 16 )$$

After reshaping Zₒᵤₜₚᵤₜ back to c×h×w, it serves as the final output of each attention head within the SFBlock. To produce the final output of the entire SFBlock, the outputs from all attention heads are concatenated along the channel dimension. A final 1×1 convolution layer is then applied as a linear projection to integrate information across the heads and ensure that the output tensor retains the same channel dimension as the input.

By integrating the efficiency of NAFBlocks with the advanced multimodal fusion capabilities of the SFBlock, the two-branch diffusion bridge backbone is designed for effective cloud removal. This dual-branch architecture combines the structural strengths of the SAR feature extraction branch with the fine details from the optical image restoration branch. The embodiments address the computational challenges of multi-step restoration while ensuring accurate cloud-free reconstructions that preserve both spatial and spectral integrity.

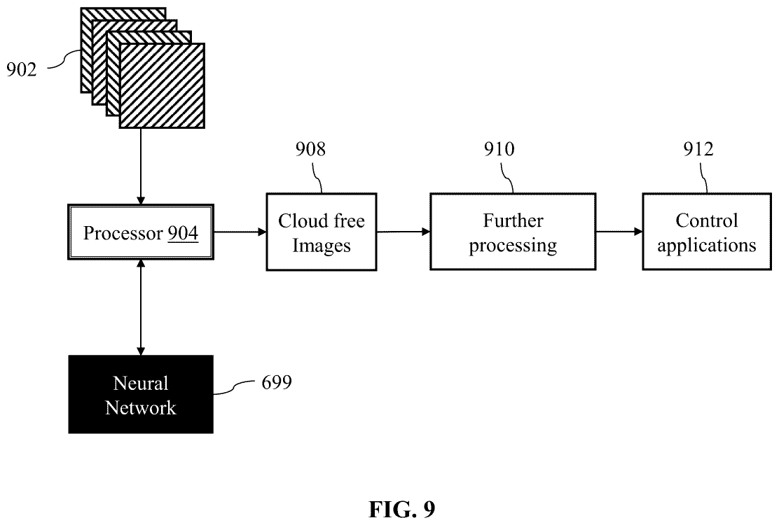

FIG. 9 shows a block diagram depicting application of the multimodal DB framework 699 employed for control tasks, according to some example embodiments. Aligned pairs 902 of a cloudy optical image of a scene and a radar image such as a synthetic aperture radar image of a scene are provided as an input to a processor 904 for reducing or removing the cloud cover in the optical image. For example, the optical and radar images may be captured by different image capturing devices. The processor 904 invokes the multimodal DB framework 699 to perform cloud removal in accordance with the framework described with respect to the previous figures. The processor 904 thus output cloudless or cloud-free images 908 that have an extent of cloud cover lower than that in the input optical image. These images are further processed at block 910 to extract information and content from the cloudless images 908 that is utilized to generate control commands for one or more control applications 912. The control applications 912 may include for example controlling an emergency responder robot in an area hit by a disaster or calamity.

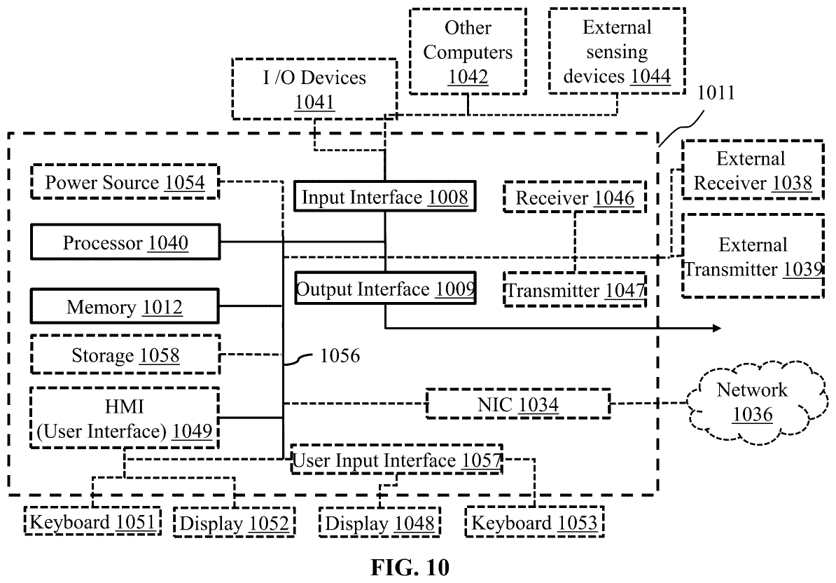

FIG. 10 shows some components of a computer system implementing the image processing system for cloud removal according to some example embodiments. The computer 1011 includes a processor 1040, computer readable memory 1012, storage 1058 and user interface 1049 with display 1052 and keyboard 1051, which are connected through bus 1056. For example, the user interface 1049 in communication with the processor 1040 and the computer readable memory 1012, acquires and stores the image data in the computer readable memory 1012 upon receiving an input from a surface, keyboard 1053, of a user interface 1057 by a user.

The computer 1011 may include a power source 1054, depending upon the application the power source 1054 may be optionally located outside of the computer 1011. Linked through bus 1056 is a user input interface 1057 adapted to connect to a display device 1048, wherein the display device 1048, generally, includes a computer monitor, camera, television, projector, or mobile device, among others. A printer interface in some embodiments, is connected through bus 1056 and adapted to connect to a printing device wherein the printing device may include a liquid inkjet printer, solid ink printer, large-scale commercial printer, thermal printer, UV printer, or dye-sublimation printer, among others. A network interface controller (NIC) 1034 is adapted to connect through the bus 1056 to a network 1036, wherein image data or other data, among other things, can be rendered on a third party display device, third party imaging device, and/or third party printing device outside of the computer 1011.

Still referring to FIG. 10, the image data or other data, among other things, may be transmitted over a communication channel of the network 1036, and/or stored within the storage system 1058 for storage and/or further processing. Further, the time series data or other data may be received wirelessly or hard wired from a receiver 1046 (or external receiver 1038) or transmitted via a transmitter 1047 (or external transmitter 1039) wirelessly or hard wired, the receiver 1046 and transmitter 1047 are both connected through the bus 1056. The computer 1011 may be connected via an input interface 1008 to external sensing devices 1044 and external input/output devices 1041. For example, the external sensing devices 1044 may include sensors gathering data before-during-after of the collected time-series data of the machine. The computer 1011 may be connected to other external computers 1042. An output interface 1009 may be used to output the processed data from the processor 1040. It is noted that a user interface 1049 in communication with the processor 1040 and the non-transitory computer readable storage medium 1012, acquires and stores the region data in the non-transitory computer readable storage medium 1012 upon receiving an input from a display 1052 of the user interface 1049 by a user.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

The above description provides exemplary embodiments only, and is not intended to limit the scope, applicability, or configuration of the disclosure. Rather, the above description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the above description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

Claimed is:

1. A method for generating a cloud-free optical satellite image from a cloudy optical satellite image, wherein the method uses a processor coupled with stored instructions implementing the method, wherein the instructions, when executed by the processor carry out steps of the method, comprising:
receiving the cloudy optical satellite image;
iteratively applying a reverse diffusion bridge process to the cloudy optical satellite image over a sequence of one or more time steps to produce the cloud-free optical satellite image, wherein, for each iteration at an intermediate time step, the reverse diffusion bridge process comprises:
applying a trained diffusion bridge model to a current input optical image generated by a previous iteration of the reverse diffusion bridge process to produce an intermediate optical image with reduced cloud-induced noise; and
combining the current input optical image with the intermediate optical image to generate a refined optical image as input for a subsequent iteration; and
outputting the cloud-free optical satellite image generated by the reverse diffusion bridge process.

2. The method of claim 1, wherein the trained diffusion bridge model is trained to iteratively recover the cloud-free optical image by modeling a deterministic transition between an initial cloudy image distribution and a target cloud-free image distribution.

3. The method of claim 2, wherein the training comprises:
training the diffusion bridge model using a forward process that combines the cloudy optical satellite image and the cloud-free optical image at each time step, wherein the combination reflects the target cloud-free image distribution; and
training the diffusion bridge model using a reverse process that iteratively refines the cloudy optical image by progressively removing cloud-induced noise at each time step, wherein the reverse process:
models a deterministic trajectory from the cloudy image distribution to the cloud-free image distribution; and
minimizes a loss function that measures the difference between the predicted cloud-free optical image and a ground-truth cloud-free optical image.

4. The method of claim 1, further comprising:
receiving a synthetic aperture radar (SAR) image spatially aligned with the cloudy optical satellite image; and
executing the reverse diffusion bridge process on the cloudy optical satellite image, wherein the SAR image is used as a condition to guide structural recovery of the cloud-free optical satellite image during each iteration of the reverse diffusion bridge process.

5. The method of claim 4, wherein the SAR image is processed in parallel with the cloudy optical satellite image using a two-branch architecture forming a multimodal reverse diffusion bridge process, comprising:
an optical image restoration branch configured to refine the optical image and recover fine spectral details; and
a SAR feature extraction branch configured to extract structural features from the SAR image to guide the recovery process.

6. The method of claim 5, wherein the features from the SAR image and the cloudy optical satellite image are fused at multiple levels of the reverse diffusion bridge process using SAR Fusion Blocks, each configured to align and merge the structural features from the SAR image with spectral details of the optical image.

7. The method of claim 6, wherein the SAR Fusion Blocks employ a cross-attention mechanism, wherein queries are derived from the features of the cloudy optical satellite image, and keys and values are derived from the features of the SAR image, enabling the structural information from the SAR image to guide the reconstruction of the cloud-free optical satellite image.

8. The method of claim 7, wherein the cross-attention mechanism reduces computational complexity by compressing spatial dimensions into channel dimensions.

9. The method of claim 5, wherein the SAR Feature Extraction Branch processes the SAR image using a time-embedded Nonlinear Activation-Free (NAF) encoder consisting of NAFBlocks to extract structural features, and the extracted features are fused with the optical image features to improve structural recovery during the reverse diffusion bridge process.

10. The method of claim 5, wherein the optical image restoration branch comprises a U-Net-based architecture configured to refine the cloudy optical satellite image, the U-Net-based architecture comprising:
an encoder path consisting of time-embedded Nonlinear Activation-Free (NAF) blocks that extracts hierarchical features from the cloudy optical satellite image;
a decoder path consisting of time-embedded Nonlinear Activation-Free (NAF) blocks that reconstructs the cloud-free optical satellite image from the extracted features; and
skip connections between corresponding levels of the encoder and decoder paths to preserve fine spectral details during the iterative reverse diffusion bridge process.

11. The method of claim 5,
wherein the optical image restoration branch comprises a U-Net-based architecture including an encoder path that extracts hierarchical features from the cloudy optical satellite image and a decoder path that reconstructs the cloud-free optical satellite image;
wherein the SAR feature extraction branch comprises an encoder path corresponding to the encoder of the optical image restoration branch, configured to extract structural features from the SAR image at resolutions matching those of the optical image encoder; and
wherein a cross-attention mechanism is applied at each corresponding resolution of the optical image encoder and the SAR encoder, such that queries are derived from the features of the optical image encoder, while keys and values are derived from the features of the SAR encoder.

12. The method of claim 4, wherein the iterative reverse diffusion bridge process is configured for progressively fusing features of the cloudy optical satellite image and the SAR image at each iteration;
refining intermediate outputs by integrating structural guidance from the SAR image with the spectral details of the optical image; and
producing a cloud-free optical satellite image with enhanced structural fidelity and spectral detail.

13. A system for generating a cloud-free optical satellite image from a cloudy optical satellite image, the system comprising: a processor; and a non-transitory computer-readable medium storing instructions which, when executed by the processor, cause the processor to:
receive a cloudy optical satellite image;
iteratively apply a reverse diffusion bridge process to the cloudy optical satellite image over a sequence of one or more time steps to generate a cloud-free optical satellite image, wherein, for each iteration at an intermediate time step, the reverse diffusion bridge process comprises:
applying a trained diffusion bridge model to a current input optical image generated by a previous iteration of the reverse diffusion bridge process to produce an intermediate optical image with reduced cloud-induced noise; and
combining the current input optical image with the intermediate optical image to generate a refined optical image as input for a subsequent iteration; and
output the cloud-free optical satellite image generated by the reverse diffusion bridge process.

14. The system of claim 13, wherein the trained diffusion bridge model is configured to iteratively recover a cloud-free optical image by modeling a deterministic transition between an initial cloudy image distribution and a target cloud-free image distribution.

15. The system of claim 13, wherein the non-transitory computer-readable medium stores instructions that, when executed by the processor, cause the processor to:
train the diffusion bridge model using a forward process that combines the cloudy optical satellite image and the cloud-free optical image at each time step, wherein the combination reflects the target cloud-free image distribution; and
train the diffusion bridge model using a reverse process that iteratively refines the cloudy optical image by progressively removing cloud-induced noise at each time step, wherein the reverse process: models a deterministic trajectory from the cloudy image distribution to the cloud-free image distribution; and minimizes a loss function that measures the difference between the predicted cloud-free optical image and a ground-truth cloud-free optical image.

16. The system of claim 13, further comprising:
a data acquisition module configured to receive a synthetic aperture radar (SAR) image spatially aligned with the cloudy optical satellite image;
wherein the processor is further configured to execute the reverse diffusion bridge process on the cloudy optical satellite image, wherein the SAR image is used as a condition to guide the structural recovery of the cloud-free optical satellite image during each iteration of the reverse diffusion bridge process.

17. The system of claim 16, wherein the processor executes a multimodal reverse diffusion bridge process using a two-branch architecture comprising:
an optical image restoration branch configured to refine the optical image and recover fine spectral details; and
a SAR feature extraction branch configured to extract structural features from the SAR image to guide the recovery process.

18. The system of claim 17, wherein the processor applies a cross-attention mechanism to fuse features from the SAR image and the cloudy optical satellite image at multiple levels of the reverse diffusion bridge process using SAR Fusion Blocks (SFBlocks), each configured to align and merge structural features from the SAR image with spectral details from the optical image.

19. The system of claim 18, wherein the SAR Fusion Blocks employ a cross-attention mechanism, wherein queries are derived from the features of the cloudy optical satellite image, and keys and values are derived from the features of the SAR image, enabling the structural information from the SAR image to guide the reconstruction of the cloud-free optical satellite image.

20. The system of claim 19, wherein the cross-attention mechanism reduces computational complexity by compressing spatial dimensions into channel dimensions, improving processing efficiency while maintaining reconstruction accuracy.
